(19) United States
(12) Patent Application Publication
(10) Pub. No.: US 2004/0173252 A1
(43) Pub. Date: Sep. 9, 2004

(54) Collapsible shelter assembly

(75) Inventor: Georges Bouchard, Ste-Monique (CA)

Correspondence Address: ROBIC, 55 St Jacques, Montreal, QC, H2Y 3X2, CA

(73) Assignee: 3607933 Canada Inc.

(21) Appl. No.: 10/795,520

(22) Filed: Mar. 8, 2004

(30) Foreign Application Priority Data
Mar. 7, 2003 (CA) 2,420,345

(51) Int. Cl. A47C 1/02; A61G 15/00; E04H 15/38; E04H 15/50

(52) U.S. Cl. 135/131

(57) ABSTRACT

A collapsible frame assembly having a first supporting frame and a second supporting frame mounted onto the first supporting frame in such a manner as to be movable up and down with respect to the first supporting frame. The frame assembly having three or more lazy tong arrangements pivotally connected to the first and second supporting frames. The frame assembly also has moving mechanisms for extending and retracting the lazy tong arrangements between a retracted position and an extended position that form respectively a collapsed structure and an arch-like freestanding structure.

### FIELD OF THE INVENTION

The present invention generally relates to a collapsible frame assembly that may be used with a covering member for providing a shelter.

### BACKGROUND OF THE INVENTION

Frame assemblies are used to support covering members. Some conventional frame assemblies are assembled piece by piece, or in sections, before the covering member is placed on the frame assembly. These structures require considerable time to assemble.

Known in the art, there are U.S. Pat. Nos. 3,973,370 and 4,190,990 (MCALLISTER) which disclose a frame assembly having struts and expandable cylinders that allow the frame assembly to be automatically assembled. However, this structure is somewhat cumbersome to assemble and install as each of the ends thereof have to be anchored to the ground.

Also known in the art, there is U.S. Pat. No. Re. 33,710 (ZEIGLER) which discloses a portable shelter framework formed by a series of end-interconnecting modules capable of being expanded into arched three dimensional form and collapsed into bundled form. However, these modules are made of relatively complex components and are also cumbersome to assemble.

Also known in the art, there are U.S. Pat. No. 3,375,634 (MIKULIN); U.S. Pat. No. 5,794,640 (JANG); U.S. Pat. No. 5,813,425 (CARTER); and U.S. Pat. No. 6,230,727 (CHEN) which disclose different types of shelter assemblies that need to be manually erected and collapsed by a user, which is also cumbersome.

There is therefore a need for a collapsible frame assembly that may be automatically extended and retracted in a relatively simple manner, that may be sized for any particular use and that may be easily transported to a convenient location.

The invention as well as its numerous advantages will be better understood by reading of the following non-restrictive description of preferred embodiments made in reference to the appending drawings.

### SUMMARY OF THE INVENTION

According to the present invention, there is provided a collapsible frame assembly comprising:

a first supporting frame;

a second supporting frame mounted onto the first supporting frame in such a manner as to be movable up and down with respect to the first supporting frame;

three or more lazy tong arrangements, each lazy tong arrangement having a plurality of lazy tong members pivotally connected to each other, each lazy tong member having first and second links pivotally connected to each other at an intermediate pivot point, each lazy tong arrangement having at an end thereof one of the first links pivotally connected to the first supporting frame and one of the second links pivotally connected to the second supporting frame, and at least three of the lazy tong arrangements having at another end thereof a ground contacting means for reducing friction with the ground; and

moving means for extending and retracting the lazy tong arrangements between a retracted position and an extended position, where as the lazy tong arrangements are moved from the retracted position to the extended position, the second supporting frame is moved down with respect to the first supporting frame so that when the ground contacting means of the at least three lazy tong arrangements make contact with the ground and by further moving the lazy tong arrangements to the extended position, the first and second supporting frames are moved up with respected to the ground so as to form an arch-like freestanding structure.

### BRIEF DESCRIPTION OF THE DRAWINGS

FIG. 1 is a side view of a frame assembly according to a first preferred embodiment of the present invention in its initial collapsed position.

FIG. 2 is a rear view of the frame assembly shown in FIG. 1.

FIG. 3 is a top view of the frame assembly shown in FIG. 1.

FIG. 4 is a side view of the frame assembly of FIG. 1 in a partially extended position.

FIG. 5 is side view of the frame assembly of FIG. 1 in a fully extended position.

FIG. 6 is a rear view of the frame assembly of FIG. 1 in a fully extended position.

FIG. 7 is a top view of the frame assembly of FIG. 1 in a fully extended position.

FIG. 8 is a side view of a frame assembly according to a second preferred embodiment of the present invention in its initial collapsed position.

FIG. 9 is a rear view of the frame assembly shown in FIG. 8.

FIG. 10 is a top view of the frame assembly shown in FIG. 8.

FIG. 11 is a rear view of the frame assembly of FIG. 8 in a partially extended position.

FIG. 12 is rear view of the frame assembly of FIG. 8 in a fully extended position.

FIG. 13 is a side view of the frame assembly of FIG. 8 in a fully extended position.

FIG. 14 is a top view of the frame assembly of FIG. 8 in a fully extended position.

### DESCRIPTION OF THE PREFERRED EMBODIMENTS

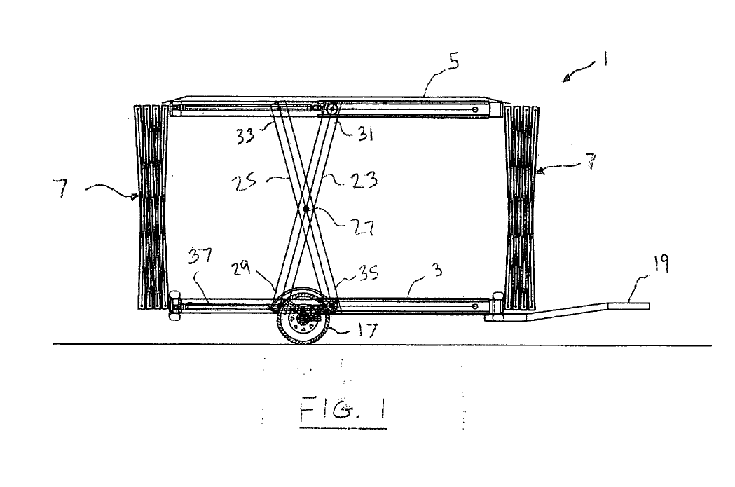

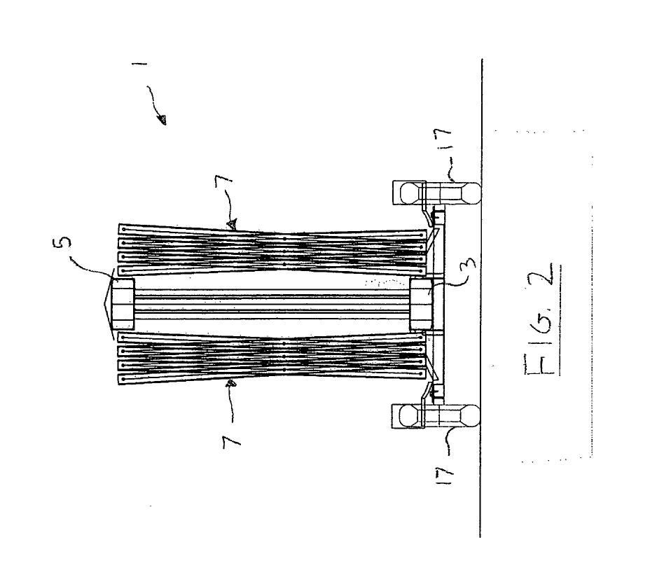

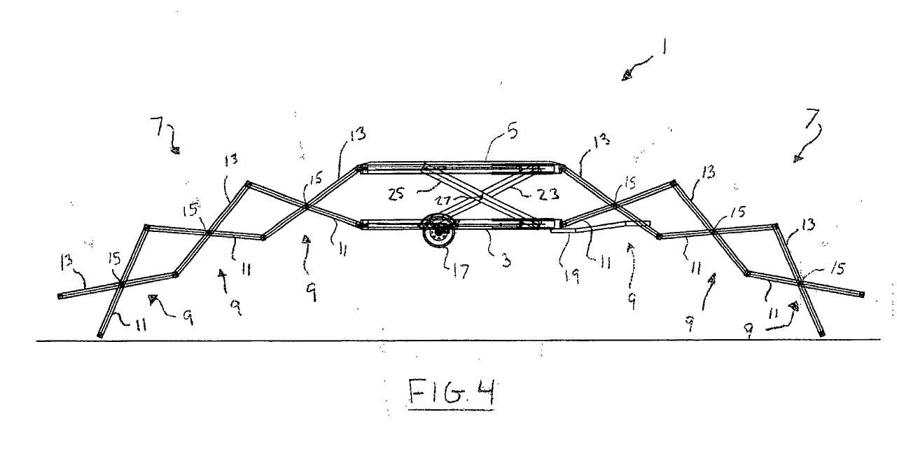

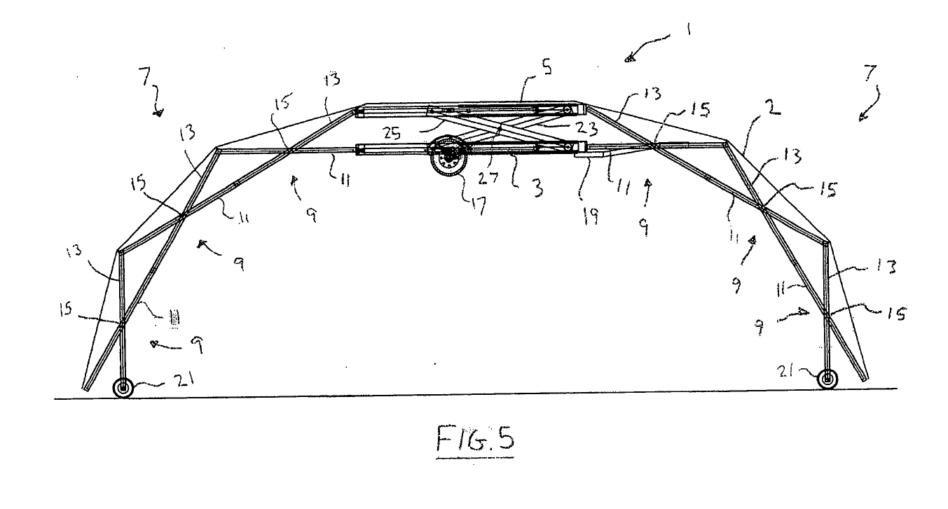

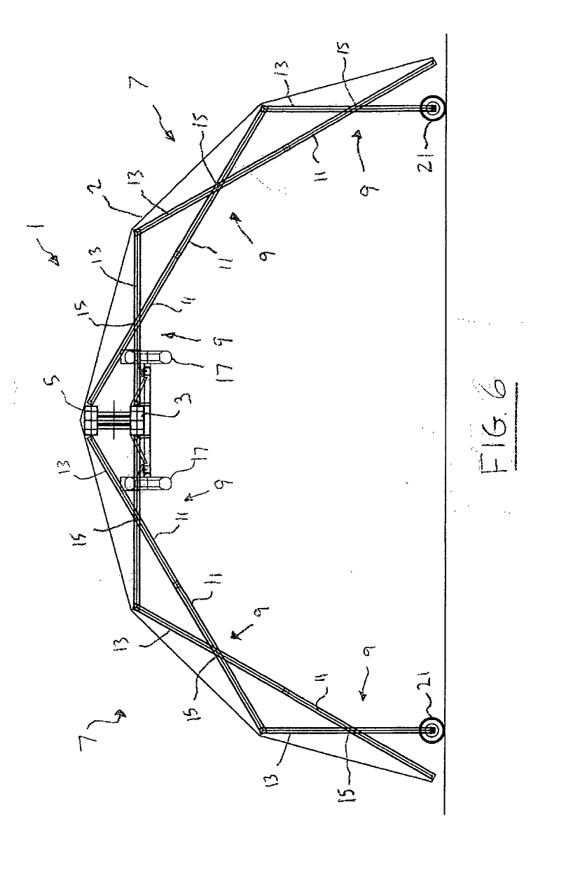

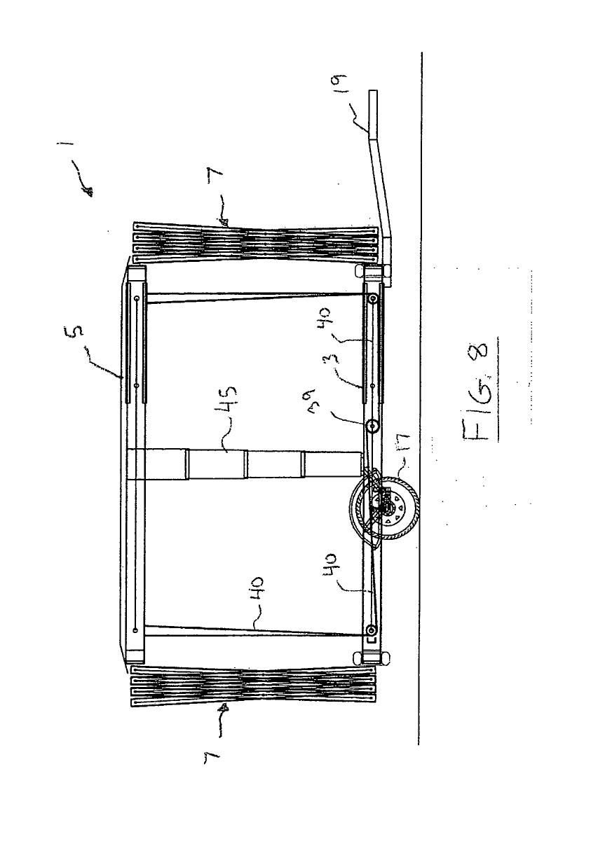

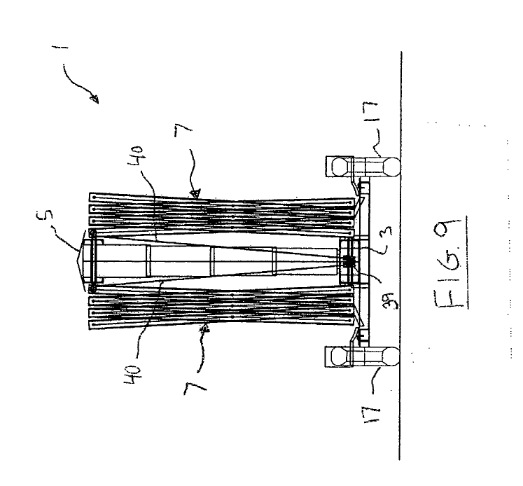

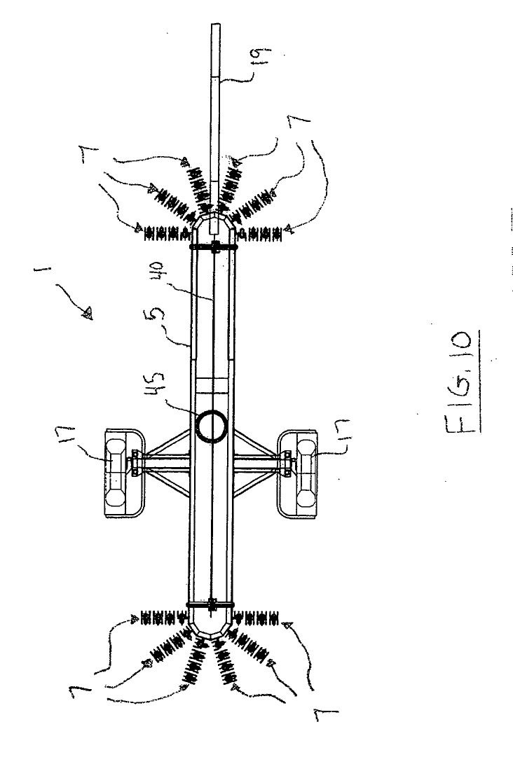

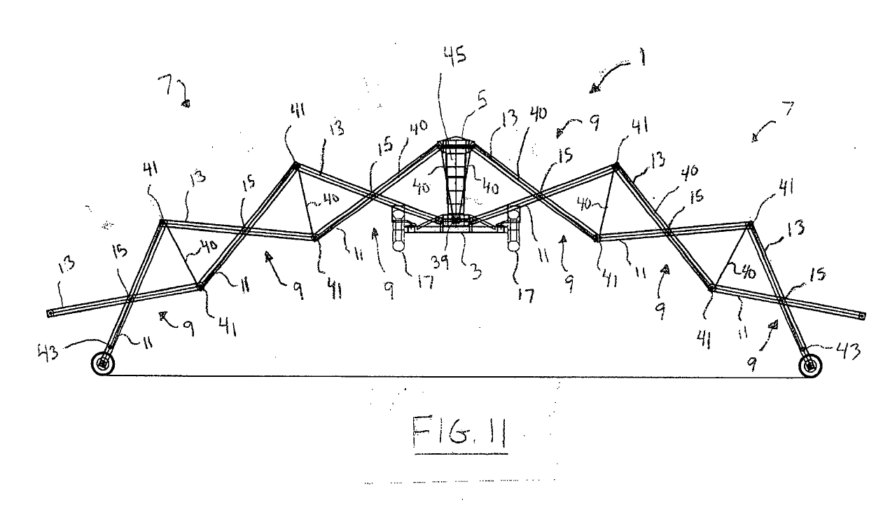

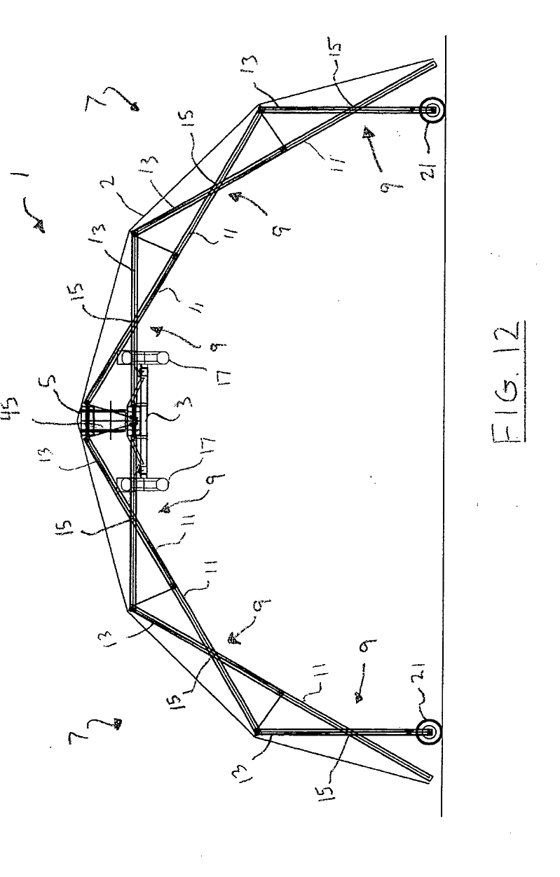

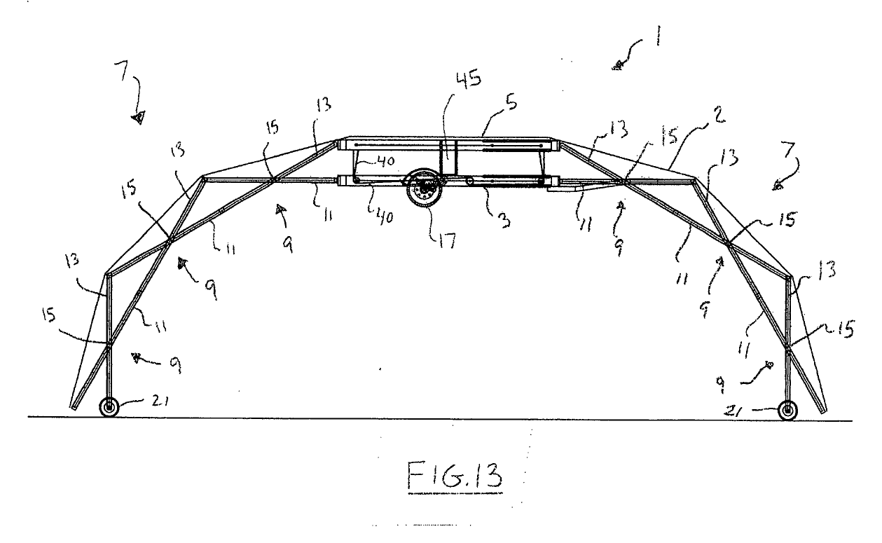

Referring to FIGS. 1 to 7 and FIGS. 8 to 14, there are respectively shown collapsible frame assemblies 1 according to first and second preferred embodiments of the present invention. In both embodiments, the frame assembly 1 includes a first supporting frame 3 and a second supporting frame 5 mounted onto the first supporting frame 3 in such a manner as to be movable up and down with respect to the first supporting frame 3. The frame assembly 1 also includes three or more lazy tong arrangements 7. As shown for example in FIGS. 4 and 11, each lazy tong arrangement 7 has a plurality of lazy tong members 9 pivotally connected to each other. Each lazy tong member 9 has first and second links 11, 13 pivotally connected to each other at an intermediate pivot point 15. Each lazy tong arrangement 7 has at an end thereof one of the first links 11 pivotally connected to the first supporting frame 3 and one of the second links 13 pivotally connected to the second supporting frame 5. At least three of the lazy tong arrangements 9 have at another end thereof a ground contacting device for reducing friction with the ground. The frame assembly also includes a moving mechanism for extending and retracting the lazy tong arrangements 7 between a retracted position, as shown for example in FIGS. 1 and 8, and an extended position, as shown for example in FIGS. 5 and 12, where as the lazy tong arrangements 7 are moved from the retracted position to the extended position, the second supporting frame 5 is moved down with respect to the first supporting frame 3 so that when the ground contacting devices of the at least three lazy tong arrangements 7 make contact with the ground and by further moving the lazy tong arrangements 7 to the extended position, the first and second supporting frames 3, 5 are moved up with respected to the ground, as shown in FIGS. 4 and 11, so as to form an arch-like freestanding structure, as shown in FIGS. 5 and 12.

Obviously, in order to collapse the structure, the same steps described above are carried out in reverse order. Therefore, when the lazy tong arrangements 7 are moved from the fully extended position, as shown in FIGS. 5 and 12, to the partially retracted position, as shown in FIGS. 4 and 11, the first and second supporting frames 3,5 are both moved down with respect to the ground. By further moving the lazy tong arrangements 7 to the retracted position, the ground engagements devices are removed from the ground and the second supporting frame 5 is moved up with respect to the first supporting frame 3 so as to form a collapsed structure, as shown for example in FIG. 1.

A cover member 2 may be installed on top of the frame assembly 1 as shown in FIGS. 5, 6, 7, 12,13 and 14 in order to serve as a shelter when the frame assembly 1 is in the freestanding extended position.

Preferably, the first supporting frame 3 is provided with a pair of supporting wheels 17 and a hauling bar 19, which is connectable to a traction vehicle for transporting the frame assembly 1 to a convenient location. Of course, the wheels 17 may be replaced by other suitable means, such as skis for example if the ground is covered with ice or snow.

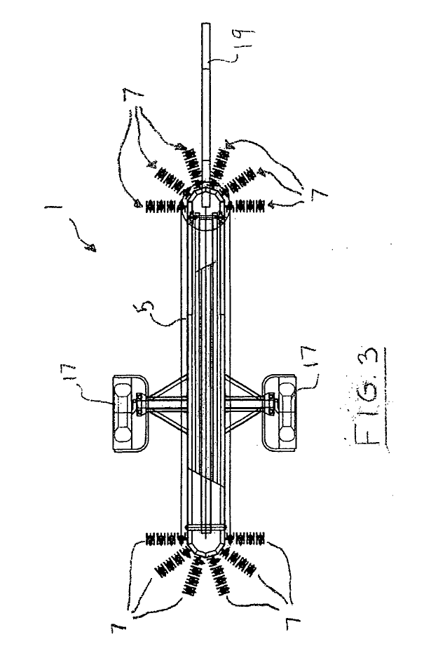

Preferably, each of the ground contacting devices include a wheel 21 pivotally connected to each of the at least three lazy tong arrangements 7. As persons skilled in the art will understand, in order to from a freestanding structure at least three lazy tongue arrangements 7 are needed. In such a case, the lazy tongue arrangements 7 may be spaced by 120 degrees from each other and each is provided with a wheel 21 for facilitating the deployment of the frame assembly 1. Of course, the actual number of lazy tongue arrangements 7 may be higher. For example, one may use twelve lazy tongue arrangements 7 connected in the manner shown in FIGS. 3, 7, 10 and 14. As shown, six lazy tongue arrangements 7 project on one side of the first and second supporting frames 3, 5 and six other lazy tongue arrangements 7 project on an opposite side of the first and second supporting frames 3, 5 to form an oblong free standing structure when the lazy tongue arrangements 7 are in the extended position.

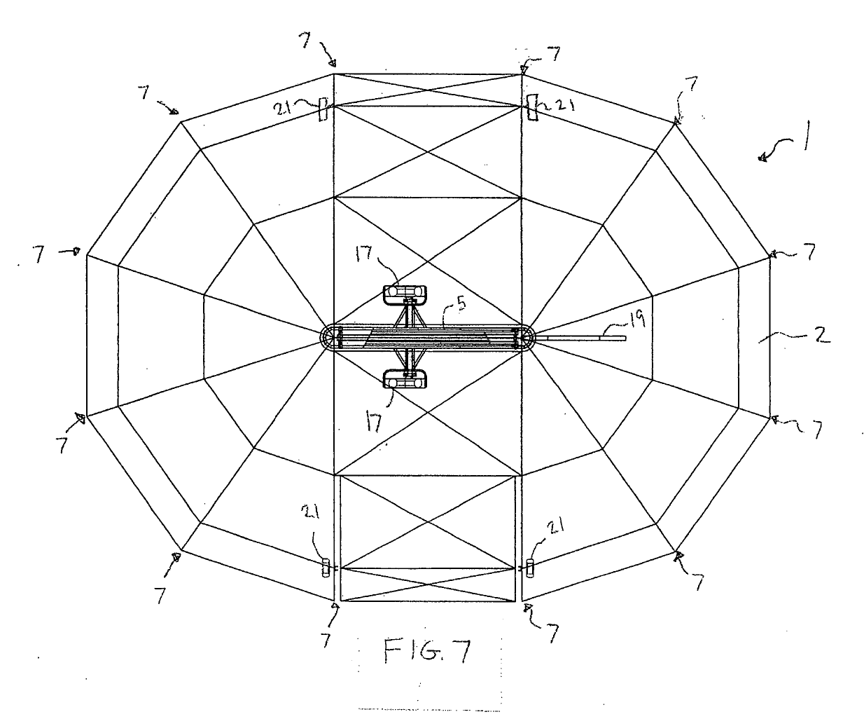

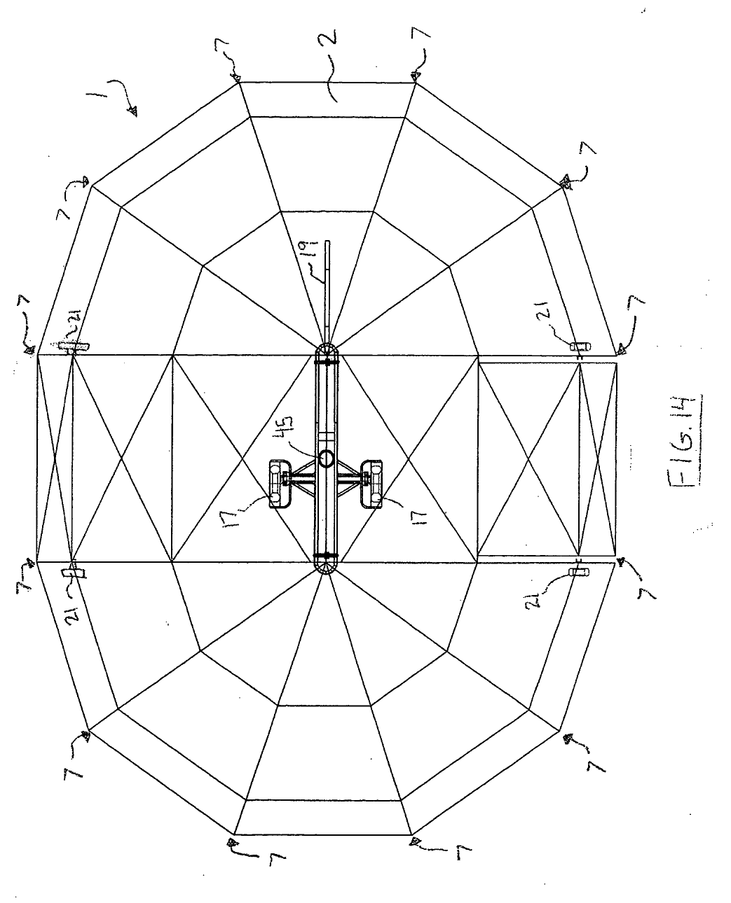

Furthermore, not all of the lazy tongue arrangements 7 need to be provided with the ground contacting devices, such as the wheels 21. In the example shown in FIGS. 7 and 14, only four of the lazy tongue arrangements 7 are provided with the wheels 21. It is to be noted that the ground contacting devices are used for reducing the friction with the ground when the lazy tongue arrangements 7 are extended and retracted, therefore other ground contacting devices may be used for this purpose, such as skis in case the ground is covered with snow or ice. The ground contacting devices may also take the form of smooth rounded ends so as to slide relative to the ground.

Referring to FIGS. 1 to 7, the moving mechanism may include first and second lazy tong bars 23, 25 pivotally connected to each other at an intermediate pivot point 27. The first bar 23 has a first end 29 pivotally connected to the first supporting frame 3 and second end 31 pivotally and slidably connected to the second supporting frame 5. The second bar 25 has a first end 33 pivotally connected to the second supporting frame 5 and a second end 35 pivotally and slidably connected to the first supporting frame 3. A hydraulic piston 37 is connected to one of the second ends 33, 35 of the lazy tong bars for moving the lazy tong bars 23, 25 between extended and retracted positions where the second supporting frame 5 is moved up and down with respect to the first supporting frame 3. Thus, when the lazy tong bars 23, 25 are in a retracted position, the lazy tong members 7 are moved in the extended position. Conversely, when the lazy tong bars 23, 25 are in an extended position, the lazy tong members 7 are moved in the retracted position. Of course, many changes may be effected to the moving mechanism. For example, a double acting cylinder vertically connecting the first and second frame members 3, 5 may be used instead of the lazy tongue bars 23, 25. The hydraulic cylinder 37 may be replaced by any suitable motor means such as an electric motor or the like.

Referring to FIGS. 8 to 14, the moving mechanism may alternatively include a winch 39 mounted on the first supporting frame 3. This winch 39 drives a set of cables 40 running through the second frame assembly 5 and into each of the lazy tongue arrangements 7 in a crisscrossing manner through a series of pulleys that are mounted at interconnection points 41 of the lazy tongue members 9. Each of the cables 40 are attached to an end point 43 of the lazy tongue arrangements 7. A telescoping stabilizing structure 45 is also connected between the first and second supporting frames 3, 5. Therefore, when the winch 39 pulls on the set of cables 40, the lazy tong arrangements 7 are moved into the extended position and the telescoping structure 45 is moved in a retracted position.

Although not shown, another set of cables may be connected directly to another winch mounted on the supporting frame 3, so that when this other winch pulls on the other set of cables, the lazy tongue arrangements 7 are moved into the retracted position. At the same time the telescoping structure 45 is moved in its extended position and the first and second frames 3, 5 are moved away from each other, similarly as explained above.

Referring to FIGS. 4, 5, 11 and 12, it should be noted that the amount of curvature of the lazy tongue arrangements 7 in the extended position is determined by the position of the intermediate pivot points 15 with respect to the center of the links 11, 13 of the lazy tong members 9. Thus, as persons skilled in the art will understand, the radius of curvature of the lazy tong arrangements 7 may be determined by the amount of offset of the pivot points 15 from the center of the corresponding links 13, 15. Also, the number of lazy tongue members 9 may be varied as well even though only thee lazy tongue members 9 are illustrated.

As shown in FIGS. 7 and 14, six lazy tongue arrangements 7 may project on one side of the first and second supporting frames 3, 5 and six other lazy tongue arrangements 7 may project on an opposite side of the first and second supporting frames 3, 5 to form an oblong free standing structure when the lazy tongue arrangements are in the extended position. Of course, many different shapes may be achieved as will be understood by those skilled in the art.

Furthermore, persons skilled in the art will understand that several of these frame assemblies 1 may be connected together by making some suitable modifications to thereby cover larger surface areas.

The frame assembly 1 according to the present invention is easy to move in extended and retracted positions and requires a very few number of workers to install and to remove. It may also be sized to fit different needs, for covering a single object for example, or for covering a very large surface with numerous objects, or persons or the like.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A collapsible frame assembly comprising:
a first supporting frame;
a second supporting frame mounted onto the first supporting frame in such a manner as to be movable up and down with respect to the first supporting frame;
three or more lazy tong arrangements, each lazy tong arrangement having a plurality of lazy tong members pivotally connected to each other, each lazy tong member having first and second links pivotally connected to each other at an intermediate pivot point, each lazy tong arrangement having at an end thereof one of the first links pivotally connected to the first supporting frame and one of the second links pivotally connected to the second supporting frame, and at least three of the lazy tong arrangements having at another end thereof a ground contacting means for reducing friction with the ground; and
moving means for extending and retracting the lazy tong arrangements between a retracted position and an extended position, where as the lazy tong arrangements are moved from the retracted position to the extended position, the second supporting frame is moved down with respect to the first supporting frame so that when the ground contacting means of the at least three lazy tong arrangements make contact with the ground and by further moving the lazy tong arrangements to the extended position, the first and second supporting frames are moved up with respected to the ground so as to form an arch-like freestanding structure.

2. The frame assembly according to claim 1, wherein the first supporting frame is provided with a pair of supporting wheels and a hauling bar connectable to a traction vehicle for transporting the frame assembly to a convenient location.

3. The frame assembly according to claim 1, wherein the ground contacting means comprise a wheel pivotally connected to each said another end of the at least three lazy tong arrangements.

4. The frame assembly according to claim 1, wherein the moving means comprise first and second lazy tong bars pivotally connected to each other at an intermediate pivot point, the first bar having a first end pivotally connected to the first supporting frame and second end pivotally and slidably connected to the second supporting frame, the second bar having a first end pivotally connected to the second supporting frame and a second end pivotally and slidably connected to the first supporting frame, and a hydraulic piston connected to one of the second ends of the lazy tong bars for moving the lazy tong bars between extended and retracted positions where the second supporting frame is moved up and down with respect to the first supporting frame.

5. The frame assembly according to claim 1, wherein the moving means comprise a winch mounted on the first supporting frame, the winch driving a set of cables running through the second frame assembly and into each of the lazy tongue arrangements in a crisscrossing manner through a series of pulleys mounted at interconnection points of the lazy tongue members, each of the cables being attached to an end point of the lazy tongue arrangements, and a telescoping stabilizing structure connected between the first and second supporting frames, so that when the winch pulls on the set of cables, the lazy tong arrangements are moved into the extended position and the telescoping structure is retracted.

6. The frame assembly according to claim 1, wherein the lazy tongue arrangements number twelve lazy tongue arrangements, six lazy tongue arrangements projecting on one side of the first and second supporting frames and six other lazy tongue arrangements projecting on an opposite side of the first and second supporting frames to form an oblong free standing structure when the lazy tongue arrangements are in the extended position.

7. The frame assembly according to claim 6, wherein four of the lazy tongue arrangements have a ground contacting means that includes a wheel pivotally connected to the four lazy tong arrangements.
